(19) United States
(12) Patent Application Publication
(10) Pub. No.: US 2026/0066733 A1
(43) Pub. Date: Mar. 5, 2026

(54) ELECTRIC MOTOR AND PUMP INCLUDING THE SAME

(71) Applicant: DELTA ELECTRONICS, INC., Taoyuan City (TW)

(72) Inventors: Hung-Lin CHOU, Taoyuan City (TW); Meng-Yu CHEN, Taoyuan City (TW); Shih-Han HUANG, Taoyuan City (TW)

(21) Appl. No.: 18/970,810

(22) Filed: Dec. 5, 2024

(30) Foreign Application Priority Data
Sep. 4, 2024 (CN) 202422165423.0

(51) Int. Cl. H02K 3/52; F04D 13/06; F04D 29/18; H02K 5/22

(52) U.S. Cl. CPC H02K 3/522; F04D 13/06; F04D 29/18; H02K 5/225; H02K 2203/09; H02K 2203/12

(57) ABSTRACT

An electric motor includes a stator housing, a first conductive terminal, a stator assembly and a rotor assembly. The first conductive terminal is disposed on the stator housing and includes a first end portion and a second end portion. The first end portion is located in a receptacle for receiving the stator assembly and has a first insertion opening. The second end portion is located in a connector structure. The guiding structure has a second insertion opening and an end surface arranged around the second insertion opening and resting against the first end portion of the first conductive terminal. The first insertion opening is narrower than the second insertion opening. The stator assembly includes a coil and a second conductive terminal connected to the coil and inserted into the first and second insertion openings. The rotor assembly is positioned to face the stator assembly.

### RELATED APPLICATIONS

This application claims priority to China Application Serial Number 202422165423.0, filed September 4, 2024, the disclosure of which is incorporated herein by reference in its entirety.

### BACKGROUND

### TECHNICAL FIELD

The present disclosure relates to an electric motor and a pump including the same.

### DESCRIPTION OF RELATED ART

Electric motors are common electromechanical devices and have a wide range of applications, including electric vehicles, fans, pumps, etc. Due to the prevalence of electric motors, the industry has devoted significant resources to the design and development of electric motors, in hope of simplifying the manufacturing process of electric motor as well as reducing the production costs.

### SUMMARY

In view of the foregoing, one of the objects of the present disclosure is to provide an electric motor having a simple structure and a low production cost, as well as a pump that includes the electric motor.

In accordance with an embodiment of the present disclosure, an electric motor includes a stator housing, a first conductive terminal, a stator assembly and a rotor assembly. The stator housing includes a base portion, a sidewall portion and a connector structure. The connector structure is disposed on the base portion. The sidewall portion is connected to the base portion and forms a receptacle with the base portion. The first conductive terminal is disposed on the stator housing and includes a first end portion and a second end portion. The second end portion is opposite to the first end portion and is located in the connector structure. The first end portion is located in the receptacle and has a first insertion opening. The stator housing further includes a guiding structure positioned to face the first end portion of the first conductive terminal and having a second insertion opening. A minimum width of the first insertion opening is less than a width of the second insertion opening, and a maximum width of the first end portion of the first conductive terminal is greater than the width of the second insertion opening. The stator assembly is disposed in the receptacle of the stator housing and includes a coil and a second conductive terminal. The second conductive terminal is connected to the coil and is inserted into the first insertion opening and the second insertion opening. The rotor assembly is positioned to face the stator assembly.

In accordance with an embodiment of the present disclosure, an electric motor includes a stator housing, a first conductive terminal, a stator assembly and a rotor assembly. The stator housing includes a base portion, a sidewall portion and a connector structure. The connector structure is disposed on the base portion. The sidewall portion is connected to the base portion and forms a receptacle with the base portion. The first conductive terminal is disposed on the stator housing and includes a first end portion and a second end portion. The second end portion is opposite to the first end portion and is located in the connector structure. The first end portion is located in the receptacle and has a first insertion opening. The stator housing further includes a guiding structure positioned to face the first end portion of the first conductive terminal and having a second insertion opening and an end surface. The end surface is arranged around the second insertion opening and rests against the first end portion of the first conductive terminal. The first insertion opening is partially or entirely narrower than the second insertion opening. The stator assembly is disposed in the receptacle of the stator housing and includes a coil and a second conductive terminal. The second conductive terminal is connected to the coil and is inserted into the first insertion opening and the second insertion opening. The rotor assembly is positioned to face the stator assembly.

In one or more embodiments of the present disclosure, the first insertion opening has a first inner surface, and the second insertion opening has a second inner surface. An orthogonal projection of the second inner surface onto the base portion surrounds an orthogonal projection of the first inner surface onto the base portion.

In one or more embodiments of the present disclosure, the first end portion of the first conductive terminal includes a curved portion extending curvedly to form a concavity. The concavity acts as the first insertion opening.

In one or more embodiments of the present disclosure, the curved portion has an outer surface away from the second conductive terminal, and the outer surface of the curved portion is wider than the second insertion opening.

In one or more embodiments of the present disclosure, the second insertion opening has a first end and a second end. The first end faces the first conductive terminal, and the second end is away from the first conductive terminal. An inner surface of the second insertion opening has a sloping region such that the second insertion opening is narrower at the first end than the second end.

In one or more embodiments of the present disclosure, the first end portion of the first conductive terminal has an inner side that is away from the sidewall portion of the stator housing. The guiding structure further has a side opening exposing the inner side of the first end portion of the first conductive terminal.

In one or more embodiments of the present disclosure, the stator assembly further includes a bobbin. The coil and the second conductive terminal are disposed on the bobbin. One of the bobbin and the stator housing includes a rib structure. Another one of the bobbin and the stator housing has a groove for receiving the rib structure. The rib structure and the groove extend along a direction substantially normal to the base portion of the stator housing.

In one or more embodiments of the present disclosure, the bobbin includes a first interlocking structure. The stator housing further includes a second interlocking structure. The second interlocking structure is disposed on an inner surface of the sidewall portion and interlocks with the first interlocking structure.

In one or more embodiments of the present disclosure, one of the first interlocking structure and the second interlocking structure includes a bump. Another one of the first interlocking structure and the second interlocking structure includes a clamp structure clamping the bump.

In one or more embodiments of the present disclosure, one of the first interlocking structure and the second interlocking structure includes a snap-fit receptor, and another one of the first interlocking structure and the second interlocking structure includes a snap-fit feature fixedly engaging the snap-fit receptor.

In one or more embodiments of the present disclosure, the stator housing further includes a stopper structure. The stopper structure is disposed on an inner surface of the sidewall portion and is configured to block the stator assembly from moving in a first direction. The electric motor further includes a second housing. The second housing covers the receptacle of the stator housing and is configured to block the stator assembly from moving in a second direction opposite to the first direction.

In one or more embodiments of the present disclosure, the first conductive terminal is embedded in the stator housing.

In accordance with an embodiment of the present disclosure, a pump includes the electric motor described above, a fluid chamber, and an impeller connected to the rotor assembly of the electric motor and disposed in the fluid chamber.

In sum, the electric motor of the present disclosure includes a stator housing and a stator assembly. A first conductive terminal is provided on the stator housing. One end of the first conductive terminal has a first insertion opening. The stator assembly includes a second conductive terminal to be joined with the first conductive terminal. The stator assembly can be combined with the stator housing by an assembly operation. A guiding structure of the stator housing can guide the second conductive terminal to enter the first insertion opening of the first conductive terminal, and the stator assembly is thereby brought into connection with the stator housing. Compared to conventional electric motors that rely on soldering to combine the stator housing and the stator assembly or use an additional circuit board to connect the stator housing and the stator assembly, the electric motor of the present disclosure is easier to manufacture and assemble and thus has a lower production cost.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an axonometric view of a pump in accordance with an embodiment of the present disclosure;

FIG. 2 illustrates a top view of some components of the electric motor of the pump shown in FIG. 1 (the rotor assembly is hidden);

FIG. 3 illustrates a sectional view of the electric motor shown in FIG. 2 taken along the line segment 3-3’;

FIG. 4 illustrates a sectional view of the electric motor shown in FIG. 2 taken along the line segment 4-4’;

FIG. 5 illustrates an axonometric view of the first conductive terminal shown in FIGS. 1-3;

FIG. 6 illustrates a sectional view of the pump shown in FIG. 1 taken along the line segment 6-6’;

FIG. 7 illustrates an axonometric view of the stator housing of the electric motor shown in FIGS. 2 and 3; and

FIG. 8 illustrates a cross-sectional view of the pump shown in FIG. 1, wherein the cross-section passes through the bump shown in FIG. 7.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

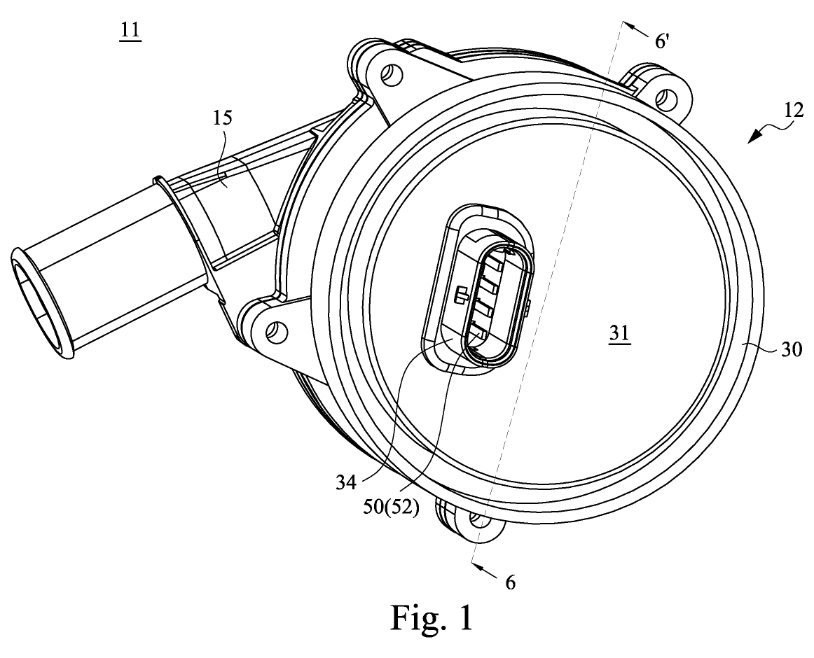

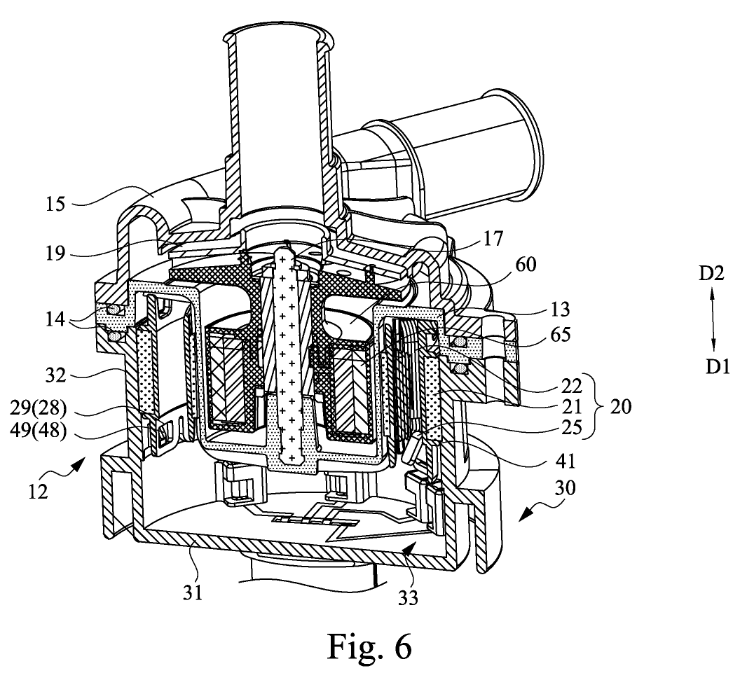

Reference is made to FIG. 1. FIG. 1 illustrates an axonometric view of a pump 11 in accordance with an embodiment of the present disclosure. The pump 11 includes an electric motor 12, a fluid chamber 15 and an impeller (e.g., the impeller 19 shown in FIG. 6). The fluid chamber 15 is disposed on a side of the electric motor 12 and is configured to receive liquid and output liquid. The impeller is connected to the electric motor 12 and is disposed in the fluid chamber 15. The impeller is driven by the electric motor 12 to rotate in the fluid chamber 15, so as to increase liquid pressure and then output liquid. In an example, the pump 11 can be incorporated as part of a cooling system of a vehicle. The pump 11 can drive a cooling liquid to flow pass at least one heat source in the vehicle (e.g., a battery pack of an electric vehicle) to control the temperature of the heat source.

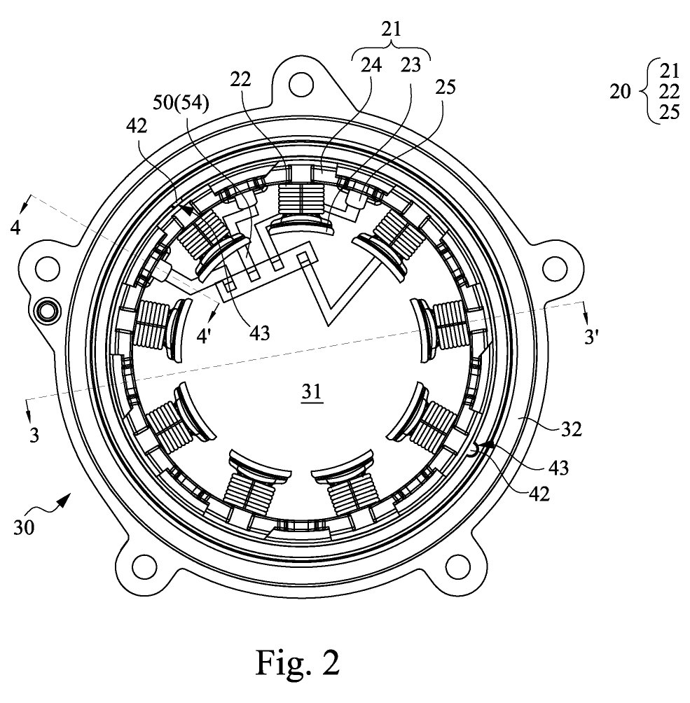

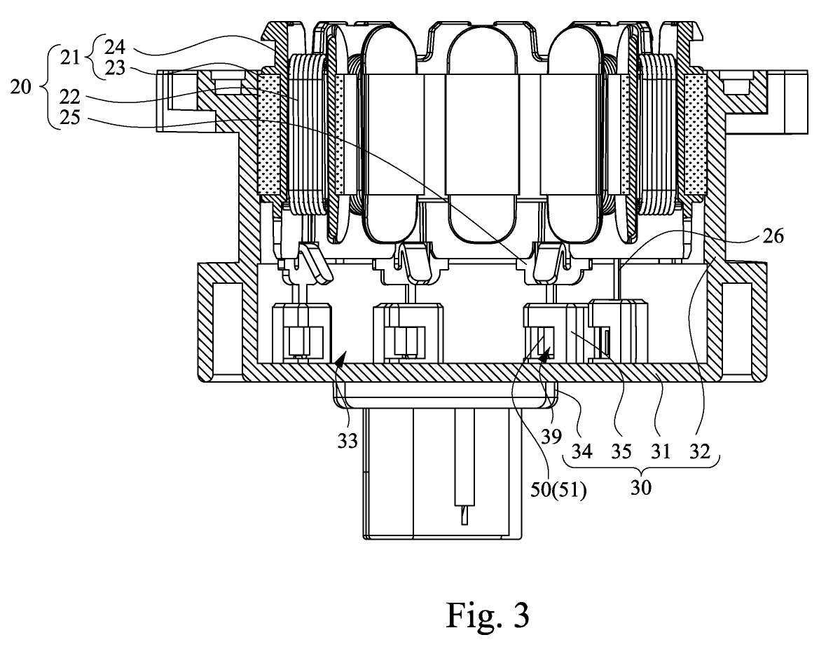

Reference is made additionally to FIGS. 2 and 3. FIG. 2 illustrates a top view of some components of the electric motor 12 of the pump 11 shown in FIG. 1 (with the rotor assembly being hidden), and FIG. 3 illustrates a sectional view of the electric motor 12 shown in FIG. 2 taken along the line segment 3-3’. As shown in FIGS. 1-3, the electric motor 12 includes a stator assembly 20 and a stator housing 30 that receives the stator assembly 20. The stator housing 30 includes a base portion 31 and a sidewall portion 32. The sidewall portion 32 is connected to the base portion 31 and forms a receptacle 33 with the base portion 31. The stator assembly 20 is disposed in the receptacle 33 of the stator housing 30.

As shown in FIGS. 1-3, the stator assembly 20 includes a bobbin 21 and a plurality of coils 22. The bobbin 21 is disposed on the sidewall portion 32 of the stator housing 30. The coils 22 are disposed on the bobbin 21 and are arranged circumferentially in the receptacle 33. The bobbin 21 may include a magnetic core 23, and the coils 22 are wound on the magnetic core 23. In some embodiments, the bobbin 21 further includes a covering member 24 that covers the magnetic core 23. The covering member 24 is, for example, formed of plastic material.

As shown in FIGS. 1-3, the stator assembly 20 further includes at least one second conductive terminal 25 disposed on the bobbin 21 and electrically connected to the coils 22. The coils 22 can receive electric power via the second conductive terminal 25 and create a magnetic field that causes a rotor assembly of the electric motor 12 (e.g., the rotor assembly 60 shown in FIG. 6), as well as the impeller connected to the rotor assembly (e.g., the impeller 19 shown in FIG. 6), to rotate. The second conductive terminal 25 can be affixed to the bobbin 21 by snap fitting or other suitable means. The second conductive terminal 25 is positioned on an edge of the bobbin 21 that faces the base portion 31 of the stator housing 30, and the second conductive terminal 25 projects from said edge of the bobbin 21. In some embodiments, the second conductive terminal 25 may include a metal sheet or a metal pin.

As shown in FIGS. 1-3, in the illustrate embodiment, the electric motor 12 is a three-phase AC motor. The coils 22 can be divided into three groups, each corresponding to one of the three phases of the electric current. The stator assembly 20 includes three second conductive terminals 25 connected to the three groups of the coils 22, respectively. Moreover, the stator assembly 20 can further include a fourth second conductive terminal 26 for grounding.

As shown in FIGS. 1-3, the stator housing 30 further includes a connector structure 34. The connector structure 34 is disposed on the base portion 31 and is located on a side of the base portion 31 away from the receptacle 33. The electric motor 12 further includes at least one first conductive terminal 50 (e.g., metal pin) disposed on the stator housing 30. Each of the at least one first conductive terminal 50 is connected to a respective second conductive terminal 25 and extends to the connector structure 34. A system (e.g., a vehicle) that utilizes the pump 11 can be connected to the connector structure 34, and the system can provide power to or control the electric motor 12 via the first conductive terminal 50 arranged in the connector structure 34. In this way, the operation of the pump 11 can be controlled by the system.

As shown in FIGS. 1-3, the first conductive terminal 50 includes a first end portion 51 and a second end portion 52. The first end portion 51 is located in the receptacle 33. The second end portion 52 is opposite to the first end portion 51 and is located in the connector structure 34. In some embodiments, the first conductive terminal 50 is embedded in the stator housing 30. In an example, the stator housing 30 may be formed of plastic material. The stator housing 30 and the first conductive terminal 50 can be created by an insert molding process, in which the first conductive terminal 50 made of metal material is wrapped by the stator housing 30 made of plastic material. In some embodiments, the first end portion 51 and the second end portion 52 of the first conductive terminal 50 projects from the base portion 31 of the stator housing 30. The first conductive terminal 50 further includes a middle section 54. The middle section 54 is connected between the first end portion 51 and the second end portion 52, and the middle section 54 is embedded in the base portion 31 of the stator housing 30.

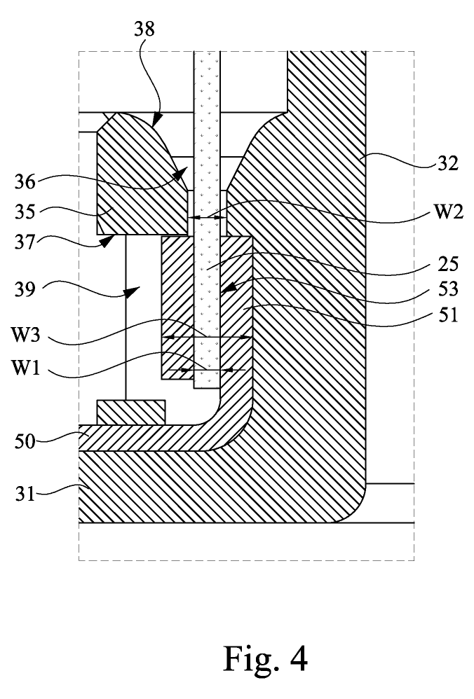

Reference is made additionally to FIG. 4. FIG. 4 illustrates a sectional view of the electric motor 12 shown in FIG. 2 taken along the line segment 4-4’. As shown in FIGS. 3 and 4, the first end portion 51 of the first conductive terminal 50 has a first insertion opening 53. The second conductive terminal 25 of the stator assembly 20 is fixedly inserted into the first insertion opening 53 and is thereby brought into connection with the first conductive terminal 50. By this arrangement, an assembly process that involves inserting the stator assembly 20 into the receptacle 33 of the stator housing 30 is sufficient to join the stator assembly 20 to the first conductive terminal 50, eliminating the need for soldering.

As shown in FIGS. 3 and 4, the stator housing 30 further includes at least one guiding structure 35 disposed in the receptacle 33. Each of the at least one guiding structure 35 is positioned to face the first end portion 51 of a respective first conductive terminal 50. The guiding structure 35 has a second insertion opening 36 that is aligned with the first insertion opening 53 of the first end portion 51 of a respective first conductive terminal 50. Under the guidance of the guiding structure 35, the second conductive terminal 25 of the stator assembly 20 can be accurately inserted into the first insertion opening 53 of the first conductive terminal 50 during the assembly process of the electric motor 12. Specifically, when the stator assembly 20 is assembled into the stator housing 30, the second conductive terminal 25 is first inserted into the second insertion opening 36 of the guiding structure 35. Once the second conductive terminal 25 enters the guiding structure 35, the second conductive terminal 25 is guided by the guiding structure 35 to enter the first insertion opening 53 of the first conductive terminal 50 and become joined with the first conductive terminal 50. In some embodiments, the guiding structure 35 is integrally formed with the base portion 31 and/or the sidewall portion 32 of the stator housing 30.

As shown in FIG. 4, the guiding structure 35 further has an end surface 37. The end surface 37 is arranged around the second insertion opening 36 and rests against the first end portion 51 of the first conductive terminal 50. The first insertion opening 53 is partially or entirely narrower than the second insertion opening 36. By this arrangement, the first conductive terminal 50 and the second conductive terminal 25 can be tightly joined to prevent disconnection of the first conductive terminal 50 and the second conductive terminal 25. In addition, the first conductive terminal 50 may be flexible to deal mechanical tolerance issues, such that each of the at least one first conductive terminal 50 can be firmly and stably connected to a respective second conductive terminal 25.

As shown in FIG. 4, in some embodiments, a minimum width W1 of the first insertion opening 53 of the first conductive terminal 50 is less than a width W2 of the second insertion opening 36 of the guiding structure 35 (e.g., the width of the second insertion opening 36 at an end of the second insertion opening 36 that faces the first conductive terminal 50), and a maximum width W3 of the first end portion 51 of the first conductive terminal 50 is greater than the width W2 of the second insertion opening 36. In some embodiments, the first insertion opening 53 has a first inner surface, and the second insertion opening 36 has a second inner surface. An orthogonal projection of the second inner surface onto the base portion 31 of the stator housing 30 surrounds an orthogonal projection of the first inner surface onto the base portion 31. The term “orthogonal projection” refers to a projection made along a direction substantially normal to the base portion 31.

As shown in FIG. 4, in some embodiments, the second insertion opening 36 of the guiding structure 35 has a first end and a second end. The first end faces the first conductive terminal 50, and the second end is away from the first conductive terminal 50. An inner surface of the second insertion opening 36 has a sloping region 38 such that the second insertion opening 36 is narrower at the first end than the second end. By this arrangement, the guiding structure 35 can guide the second conductive terminal 25 to the right position when the second conductive terminal 25 is slightly off position, such that the second conductive terminal 25 can be accurately inserted into the first insertion opening 53 of the first conductive terminal 50.

As shown in FIG. 4, in some embodiments, the first end portion 51 of the first conductive terminal 50 has an inner side that is away from the sidewall portion 32 of the stator housing 30. The guiding structure 35 further has a side opening 39 exposing the inner side of the first end portion 51 of the first conductive terminal 50 (the side opening 39 is also shown in FIG. 3). The side opening 39 can provide space for the first conductive terminal 50 to deform when the second conductive terminal 25 is inserted into the first insertion opening 53 of the first conductive terminal 50. Furthermore, having the side opening 39 makes the stator assembly 20 easier to manufacture (e.g., can lower the complexity of injection molding process).

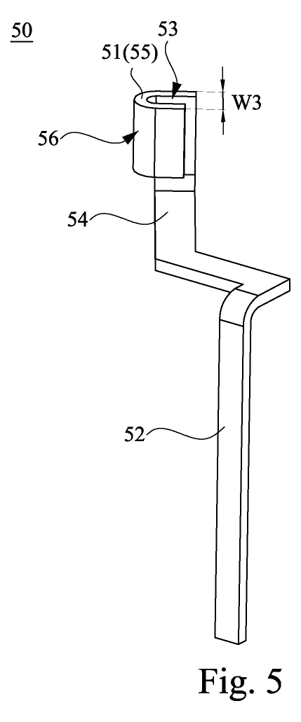

Reference is made additionally to FIG. 5. FIG. 5 illustrates an axonometric view of the first conductive terminal 50 shown in FIGS. 1-3. As mentioned above, the first conductive terminal 50 includes the first end portion 51, the second end portion 52, and the middle section 54 connected between the first end portion 51 and the second end portion 52. The first end portion 51 and the second end portion 52 are bent relative to the middle section 54, and the first end portion 51 and the second end portion 52 are bent in opposite directions. In some embodiments, the first end portion 51 of the first conductive terminal 50 includes a curved portion 55 extending curvedly to form a concavity. The concavity acts as the first insertion opening 53.

As shown in FIGS. 4 and 5, in some embodiments, the curved portion 55 has an outer surface 56 away from the concavity (i.e., away from the first insertion opening 53, or away from the second conductive terminal 25 when the second conductive terminal 25 is inserted into the first insertion opening 53). The outer surface 56 of the curved portion 55 is wider than the second insertion opening 36 of the guiding structure 35. The outer surface 56 may include two opposite wall portions. The distance between the two wall portions (e.g., the distance may be equal to the maximum width W3 mentioned above) is greater than the width W2 of the second insertion opening 36 of the guiding structure 35.

Reference is made to FIG. 6. FIG. 6 illustrates a sectional view of the pump 11 shown in FIG. 1 taken along the line segment 6-6’. As shown in FIG. 6, the electric motor 12 further includes a rotor assembly 60. The rotor assembly 60 is disposed in the receptacle 33 and is positioned to face the stator assembly 20. The stator assembly 20 is generally a circular structure, and the rotor assembly 60 can be positioned at the center of the stator assembly 20. The electric motor 12 further includes a shaft 17 extending through the center of the rotor assembly 60. The rotor assembly 60 includes a plurality of magnets 65 (e.g., permanent magnets) positioned to face the coils 22 of the stator assembly 20. The coils 22, when supplied with electric current, create a magnetic field. The rotor assembly 60, which includes the magnets 65, rotates on the shaft 17 under the influence of the magnetic field. The impeller 19 of the pump 11 is connected to the rotor assembly 60 and thus rotates with the rotor assembly 60.

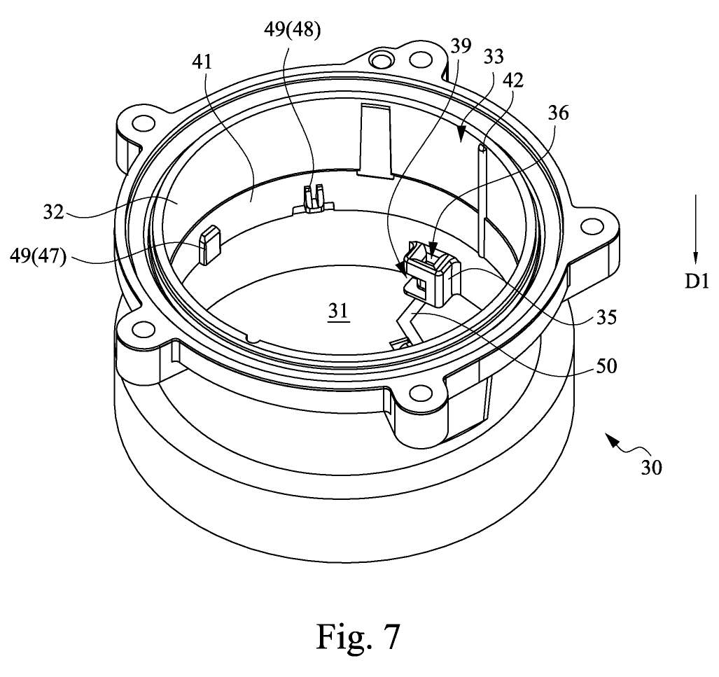

Reference is made additionally to FIG. 7. FIG. 7 illustrates an axonometric view of the stator housing 30 of the electric motor 12 shown in FIGS. 2 and 3. As shown in FIGS. 6 and 7, in some embodiments, the stator housing 30 further includes a stopper structure 41. The stopper structure 41 is disposed on an inner surface of the sidewall portion 32 and is configured to block the stator assembly 20 from moving in a first direction D1. The electric motor 12 further includes a second housing 13. The second housing 13 covers the receptacle 33 of the stator housing 30 and is configured to block the stator assembly 20 from moving in a second direction D2 opposite to the first direction D1. The stopper structure 41 and the second housing 13 can prevent displacement of the stator assembly 20 in the receptacle 33.

As shown in FIGS. 6 and 7, in some embodiments, the second housing 13 abuts against an edge of the bobbin 21 away from the base portion 31 to retrain movement of the stator assembly 20. In some embodiments, the stopper structure 41 is a flange formed on the inner surface of the sidewall portion 32. The flange engages the bobbin 21 to retrain movement of the stator assembly 20.

As shown in FIGS. 6 and 7, in some embodiments, at least one rubber ring 14 can be provided between the stator housing 30 and the second housing 13 and/or between the fluid chamber 15 and the second housing 13, so as to seal the receptacle 33 and/or the interior of the fluid chamber 15.

As shown in FIGS. 6 and 7, in some embodiments, the bobbin 21 includes a first interlocking structure 29. The stator housing 30 further includes a second interlocking structure 49. The second interlocking structure 49 is disposed on the inner surface of the sidewall portion 32 and interlocks with the first interlocking structure 29 to prevent displacement of the stator assembly 20 in the receptacle 33. In some embodiments, the second interlocking structure 49 includes a snap-fit receptor 48, and the first interlocking structure 29 includes a snap-fit feature 28 fixedly engaging the snap-fit receptor 48. In other embodiments, the snap-fit feature and the snap-fit receptor can be swapped, i.e., the first interlocking structure 29 can include the snap-fit receptor, and the second interlocking structure 49 can include the snap-fit feature fixedly engaging the snap-fit receptor.

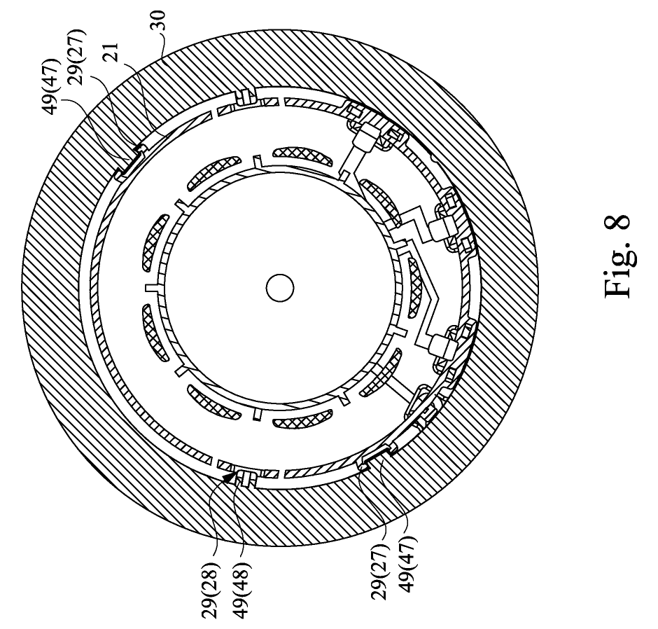

Reference is made additionally to FIG. 8. FIG. 8 illustrates a cross-sectional view of the pump 11 shown in FIG. 1, wherein the cross-section passes through the bump 47 shown in FIG. 7. As shown in FIGS. 7 and 8, in some embodiments, the second interlocking structure 49 includes at least one bump 47, and the first interlocking structure 29 includes at least one clamp structure 27 clamping the bump 47. In some embodiments, the clamp structure 27 includes two hooks, and the bump 47 is held in a gap between the two hooks. In other embodiments, the bump and the clamp structure can be swapped, i.e., the first interlocking structure 29 can include the bump, and the second interlocking structure 49 can include the clamp structure clamping the bump.

Referring to FIGS. 2 and 7, in some embodiments, the stator housing 30 includes a rib structure 42, and the bobbin 21 of the stator assembly 20 has a groove 43 for receiving the rib structure 42. The rib structure 42 and the groove 43 extend along the first direction D1, which is substantially normal to the base portion 31 of the stator housing 30. In some embodiments, the bobbin 21 can include another rib structure 42, and the stator housing 30 can have another groove 43 for receiving the rib structure 42.

The groove 43 and the rib structure 42 can facilitate correct positioning of the stator assembly 20 in the stator housing 30. Specifically, when inserting the stator assembly 20 into the stator housing 30, aligning the groove 43 and the rib structure 42 automatically guarantees that the second conductive terminal 25 can correctly pass through the guiding structure 35 and be inserted into the first insertion opening 53 of the first conductive terminal 50.

It should be noted that, aside from being incorporated as part of the pump 11, the electric motor 12 of the present disclosure may have other use cases. For example, the electric motor 12 can be incorporated as part of a fan, or the electric motor 12 may also be used to power electric vehicles. However, the use cases of the electric motor 12 of the present disclosure are not limited to the examples mentioned above. Other use cases are possible.

In sum, the electric motor of the present disclosure includes a stator housing and a stator assembly. A first conductive terminal is provided on the stator housing. One end of the first conductive terminal has a first insertion opening. The stator assembly includes a second conductive terminal to be joined with the first conductive terminal. The stator assembly can be combined with the stator housing by an assembly operation. A guiding structure of the stator housing can guide the second conductive terminal to enter the first insertion opening of the first conductive terminal, and the stator assembly is thereby brought into connection with the stator housing. Compared to conventional electric motors that rely on soldering to combine the stator housing and the stator assembly or use an additional circuit board to connect the stator housing and the stator assembly, the electric motor of the present disclosure is easier to manufacture and assemble and thus has a lower production cost.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. An electric motor, comprising:
a stator housing comprising a base portion, a sidewall portion and a connector structure, the connector structure being disposed on the base portion, the sidewall portion being connected to the base portion and forming a receptacle with the base portion;
a first conductive terminal disposed on the stator housing, wherein the first conductive terminal comprises a first end portion and a second end portion, the second end portion is opposite to the first end portion and is located in the connector structure, the first end portion is located in the receptacle and has a first insertion opening, wherein the stator housing further comprises a guiding structure positioned to face the first end portion of the first conductive terminal and having a second insertion opening, wherein a minimum width of the first insertion opening is less than a width of the second insertion opening, and a maximum width of the first end portion of the first conductive terminal is greater than the width of the second insertion opening;
a stator assembly disposed in the receptacle of the stator housing and comprising a coil and a second conductive terminal, wherein the second conductive terminal is connected to the coil and is inserted into the first insertion opening and the second insertion opening; and
a rotor assembly positioned to face the stator assembly.

2. The electric motor of claim 1, wherein the first insertion opening has a first inner surface, the second insertion opening has a second inner surface, and an orthogonal projection of the second inner surface onto the base portion surrounds an orthogonal projection of the first inner surface onto the base portion.

3. The electric motor of claim 1, wherein the first end portion of the first conductive terminal comprises a curved portion extending curvedly to form a concavity, and the concavity acts as the first insertion opening.

4. The electric motor of claim 3, wherein the curved portion has an outer surface away from the second conductive terminal, and the outer surface of the curved portion is wider than the second insertion opening.

5. The electric motor of claim 1, wherein the second insertion opening has a first end and a second end, the first end faces the first conductive terminal, and the second end is away from the first conductive terminal, wherein an inner surface of the second insertion opening has a sloping region such that the second insertion opening is narrower at the first end than the second end.

6. The electric motor of claim 1, wherein the first end portion of the first conductive terminal has an inner side that is away from the sidewall portion of the stator housing, and the guiding structure further has a side opening exposing the inner side of the first end portion of the first conductive terminal.

7. The electric motor of claim 1, wherein the stator assembly further comprises a bobbin, the coil and the second conductive terminal are disposed on the bobbin, wherein one of the bobbin and the stator housing comprises a rib structure, and another one of the bobbin and the stator housing has a groove for receiving the rib structure, wherein the rib structure and the groove extend along a direction substantially normal to the base portion of the stator housing.

8. The electric motor of claim 1, wherein the stator assembly further comprises a bobbin, the coil and the second conductive terminal are disposed on the bobbin, wherein the bobbin comprises a first interlocking structure, the stator housing further comprises a second interlocking structure, the second interlocking structure is disposed on an inner surface of the sidewall portion and interlocks with the first interlocking structure.

9. The electric motor of claim 8, wherein one of the first interlocking structure and the second interlocking structure comprises a bump, another one of the first interlocking structure and the second interlocking structure comprises a clamp structure clamping the bump.

10. The electric motor of claim 8, wherein one of the first interlocking structure and the second interlocking structure comprises a snap-fit receptor, another one of the first interlocking structure and the second interlocking structure comprises a snap-fit feature fixedly engaging the snap-fit receptor.

11. The electric motor of claim 1, wherein the stator assembly further comprises a bobbin, the coil and the second conductive terminal are disposed on the bobbin, wherein the stator housing further comprises a stopper structure, the stopper structure is disposed on an inner surface of the sidewall portion and is configured to block the stator assembly from moving in a first direction, wherein the electric motor further comprises a second housing, the second housing covers the receptacle of the stator housing and is configured to block the stator assembly from moving in a second direction opposite to the first direction.

12. The electric motor of claim 1, wherein the first conductive terminal is embedded in the stator housing.

13. A pump, comprising:
the electric motor of claim 1;
a fluid chamber; and
an impeller connected to the rotor assembly of the electric motor and disposed in the fluid chamber.

14. An electric motor, comprising:
a stator housing comprising a base portion, a sidewall portion and a connector structure, the connector structure being disposed on the base portion, the sidewall portion being connected to the base portion and forming a receptacle with the base portion;
a first conductive terminal disposed on the stator housing, wherein the first conductive terminal comprises a first end portion and a second end portion, the second end portion is opposite to the first end portion and is located in the connector structure, the first end portion is located in the receptacle and has a first insertion opening, wherein the stator housing further comprises a guiding structure positioned to face the first end portion of the first conductive terminal and having a second insertion opening and an end surface, wherein the end surface is arranged around the second insertion opening and rests against the first end portion of the first conductive terminal, wherein the first insertion opening is partially or entirely narrower than the second insertion opening;
a stator assembly disposed in the receptacle of the stator housing and comprising a coil and a second conductive terminal, wherein the second conductive terminal is connected to the coil and is inserted into the first insertion opening and the second insertion opening; and
a rotor assembly positioned to face the stator assembly.

15. The electric motor of claim 14, wherein the first insertion opening has a first inner surface, the second insertion opening has a second inner surface, and an orthogonal projection of the second inner surface onto the base portion surrounds an orthogonal projection of the first inner surface onto the base portion.

16. The electric motor of claim 14, wherein the first end portion of the first conductive terminal comprises a curved portion extending curvedly to form a concavity, and the concavity acts as the first insertion opening.

17. The electric motor of claim 16, wherein the curved portion has an outer surface away from the second conductive terminal, and the outer surface of the curved portion is wider than the second insertion opening.

18. The electric motor of claim 14, wherein the second insertion opening has a first end and a second end, the first end faces the first conductive terminal, and the second end is away from the first conductive terminal, wherein an inner surface of the second insertion opening has a sloping region such that the second insertion opening is narrower at the first end than the second end.

19. The electric motor of claim 14, wherein the first end portion of the first conductive terminal has an inner side that is away from the sidewall portion of the stator housing, and the guiding structure further has a side opening exposing the inner side of the first end portion of the first conductive terminal.

20. The electric motor of claim 14, wherein the stator assembly further comprises a bobbin, the coil and the second conductive terminal are disposed on the bobbin, and wherein:
one of the bobbin and the stator housing comprises a rib structure, and another one of the bobbin and the stator housing has a groove for receiving the rib structure, wherein the rib structure and the groove extend along a direction substantially normal to the base portion of the stator housing;
the bobbin comprises a first interlocking structure, the stator housing further comprises a second interlocking structure, the second interlocking structure is disposed on an inner surface of the sidewall portion and interlocks with the first interlocking structure; or
the stator housing further comprises a stopper structure, the stopper structure is disposed on an inner surface of the sidewall portion and is configured to block the stator assembly from moving in a first direction, wherein the electric motor further comprises a second housing, the second housing covers the receptacle of the stator housing and is configured to block the stator assembly from moving in a second direction opposite to the first direction.
